(19) United States
(12) Patent Application Publication
(10) Pub. No.: US 2022/0389244 A1
(43) Pub. Date: Dec. 8, 2022

(54) CLEANING LIQUID AND INKJET RECORDING APPARATUS LIQUID SET

(71) Applicant: KYOCERA Document Solutions Inc., Osaka (JP)

(72) Inventor: Yasuko TAKAORI, Osaka-shi (JP)

(73) Assignee: KYOCERA Document Solutions Inc., Osaka (JP)

(21) Appl. No.: 17/827,296

(22) Filed: May 27, 2022

(30) Foreign Application Priority Data
May 31, 2021 (JP) 2021-091373

(51) Int. Cl. C09D 9/04; C09D 9/00; C09D 11/322; C09D 11/40; C09D 11/023; C09D 11/037; C09D 11/107; C09D 11/108; C09D 11/102

(52) U.S. Cl. CPC C09D 9/04; C09D 9/005; C09D 11/322; C09D 11/40; C09D 11/023; C09D 11/037; C09D 11/107; C09D 11/108; C09D 11/102

(57) ABSTRACT

A cleaning liquid includes water, a surfactant, and glycol ether. The surfactant is an acetylene surfactant or a silicone surfactant. A content ratio of the glycol ether is at least 5% by mass and no greater than 15% by mass relative to a mass of the cleaning liquid. Preferably, a contact angle of the cleaning liquid to an austenitic stainless steel plate is no greater than 40 degrees.

### INCORPORATION BY REFERENCE

The present application claims priority under 35 U.S.C. § 119 to Japanese Patent Application No. 2021-091373, filed on May 31, 2021. The contents of this application are incorporated herein by reference in their entirety.

### BACKGROUND

The present disclosure relates to a cleaning liquid and an inkjet recording apparatus liquid set.

An image is printed on a recording medium by ejecting ink from a recording head included in an inkjet recording apparatus. Various cleaning liquid s have been studied for cleaning ink. For example, a cleaning agent (cleaning liquid) used for cleaning hard surfaces constituting an ink production line is known. This cleaning liquid contains an alkali agent, an alkylamine oxide, and an organic solvent with a solubility parameter at 20° C. of at least 8 and no greater than 12.

### SUMMARY

A cleaning liquid according to an aspect of the present disclosure includes water, a surfactant, and glycol ether. The surfactant is an acetylene surfactant or a silicone surfactant. A content ratio of the glycol ether is at least 5% by mass and no greater than 15% by mass relative to a mass of the cleaning liquid.

An inkjet recording apparatus liquid set according to another aspect of the present disclosure includes a first liquid and a second liquid. The first liquid is an ink and the second liquid is a cleaning liquid. The ink includes pigment particles and water. The cleaning liquid includes water, a surfactant, and glycol ether. The surfactant is an acetylene surfactant or a silicone surfactant. A content ratio of the glycol ether is at least 5% by mass and no greater than 15% by mass relative to a mass of the cleaning liquid.

### DETAILED DESCRIPTION

Embodiments of the present disclosure are described. First, the terms used in the present specification are described. A measurement value of a volume median diameter (D50) is a median diameter measured using a laser diffraction particle size distribution analyzer (“ZETASIZER Nano ZS”, product of Sysmex Corporation) unless otherwise specified. A measurement value of acid value is a value measured according to “JIS (Japanese Industrial Standard) K 0070-1992” unless otherwise specified. A measurement value of mass average molecular weight (Mw) is a value measured using gel permeation chromatography unless otherwise specified. An HLB value is a value calculated from a formula “HLB value=20×(sum of formula weight of hydrophilic part)/molecular weight” by the Griffin method unless otherwise specified. Dynamic surface tension is a value measured at 1 Hz using a bubble pressure-type dynamic surface tensiometer (“KRUSS BP-100”, product of KRUSS) unless otherwise specified. Acrylic and methacrylic may be collectively referred to as “(meth)acrylic”. “Independently of each other” in the formula description means possibly representing the same or different groups. Each of the components listed in the present specification may be used as one type alone or in a combination of two or more types. The terms used in the present specification are described above.

### First Embodiment: Cleaning Liquid

The following describes a cleaning liquid according to a first embodiment of the present disclosure. The cleaning liquid of the first embodiment is a cleaning liquid for an inkjet recording apparatus, and is an aqueous cleaning liquid containing water. The cleaning liquid of the first embodiment contains water, a surfactant, and glycol ether. The cleaning liquid may further contain a water-soluble organic solvent as necessary. In the following, a “surfactant contained in the cleaning liquid” and a “water-soluble organic solvent contained in the cleaning liquid” may be respectively referred to as a “surfactant C” and a “water-soluble organic solvent C”.

In the cleaning liquid of the first embodiment, the surfactant C is an acetylene surfactant or a silicone surfactant. A content ratio of the glycol ether is at least 5% by mass and no greater than 15% by mass relative to a mass of the cleaning liquid.

A nozzle orifice is provided on an ejection surface of a recording head included in the inkjet recording apparatus, and ink is ejected from the nozzle orifice to a recording medium. In general, a water-repellent finish is applied to the ejection surface, but since the nozzle orifice is an opening in the plate to which the water-repellent finish is applied, there are areas on the inner surface of the nozzle orifice and on a proximate area surface to the nozzle orifice on the ejection surface where the water-repellent finish is insufficient. In the following, the “inner surface of the nozzle orifice and the proximate area surface to the nozzle orifice on the ejection surface” may be referred to as the “nozzle inner surface and the proximate area surface”. When ink is not ejected for an extended period, the ink may dry and stick to the nozzle inner surface and the proximate area surface. In the following, “dried and stuck ink” may be referred to as “stuck ink”. Stuck ink can cause nozzle clogging and a decrease in the accuracy of ink placement, for example.

Stuck ink tends to occur particularly easily when using an ink with excellent quick-drying properties and adhesion to a low-absorbency recording medium with low absorbency to water and a non-absorbent recording medium which does not absorb water (in the following, a “non-absorbent recording medium and a low-absorbency recording medium” may be referred to as a “prescribed recording medium”). This is because such an ink contains large amounts (e.g., at least 0.9% by mass and no more than 3.0% by mass relative to the mass of the ink) of a binder resin (e.g., a second resin described below in a second embodiment) for binding the ink to the prescribed recording medium in addition to a pigment dispersion resin (e.g., a first resin described below in the second embodiment) for dispersing pigment particles.

Here, the cleaning liquid of the first embodiment contains an acetylene surfactant or a silicone surfactant. Furthermore, the cleaning liquid of the first embodiment contains glycol ether at a content ratio of no greater than 15% by mass relative to the mass of the cleaning liquid. Through the above, the contact angle of the cleaning liquid is reduced to a desired value and wettability is increased on the nozzle inner surface and the proximate area surface (e.g., a nozzle inner surface and a proximate area surface made of austenitic stainless steel). As a result, the cleaning liquid can suitably penetrate into a gap between the stuck ink and the nozzle inner surface or the proximate area surface.

Furthermore, the cleaning liquid of the first embodiment contains glycol ether at a content ratio of at least 5% by mass relative to the mass of the cleaning liquid. Glycol ether tends to function as a plasticizer to the pigment dispersion resin and the binder resin contained in the ink. As such, after the cleaning liquid has penetrated into the gap between the stuck ink and the nozzle inner surface or the proximate area surface, the glycol ether contained in the cleaning liquid imparts plasticity to the pigment dispersion resin and the binder resin contained in the stuck ink. As a result, the stuck ink swells, and removal of the stuck ink from the nozzle inner surface and the proximate area surface is facilitated. As such, according to the cleaning liquid of the first embodiment, the ink is favorably cleaned even in a case where an ink with excellent adhesion to the prescribed recording medium is used.

As described previously, the cleaning liquid of the first embodiment easily penetrates the gap between the stuck ink and the nozzle inner surface or the proximate area surface. As such, according to, a portion of the stuck ink (specifically, a portion of the stuck ink present near the interface of the stuck ink and the nozzle inner surface or the proximate area surface) is selectively swollen and dissolved with the cleaning liquid of the first embodiment. As such, before the stuck ink is completely dissolved, removal of the stuck ink from the nozzle inner surface and the proximate area surface is facilitated. Since it is sufficient for not all but a portion of the stuck ink to be removed, the time required to dissolve the stuck ink is reduced and the nozzle inner surface and the proximate area surface can be cleaned in a short time.

The cleaning liquid of the first embodiment exhibits excellent cleanability even when an ink suitable for a recording medium (e.g., plain paper) other than the prescribed recording medium is used. As such, the cleaning liquid of the present disclosure can be suitably used even when printing with a recording medium other than the prescribed recording medium.

Examples of the cleaning liquid of the first embodiment include a one-component cleaning liquid for cleaning using one type of cleaning liquid. The cleaning liquid and the ink described below may be housed in different containers from each other, for example.

(Contact Angle of Cleaning Liquid)

The contact angle of the cleaning liquid to an austenitic stainless steel plate is preferably no greater than 40 degrees. In the present specification, “austenitic stainless steel” refers to “SUS304” as specified in JIS (Japanese Industrial Standard) G 4305:2012 “Cold-rolled stainless steel plate, sheet and strip”. In the following, “austenitic stainless steel” may be referred to as “SUS304”. When the material of the ejection surface of the recording head included in the inkjet recording apparatus is SUS304, for example, the contact angle of the cleaning liquid to the SUS304 plate corresponds to the contact angle of the cleaning liquid to the ejection surface (in particular, the nozzle inner surface and proximate area surface).

When the contact angle of the cleaning liquid to the SUS304 plate is no greater than 40 degrees, the cleaning liquid quickly penetrates the gap between the stuck ink and the nozzle inner surface or the proximate area surface, and the ink is suitably cleaned. In order to suitably clean the ink, the contact angle of the cleaning liquid to the SUS304 plate is preferably no greater than 38 degrees. The lower limit of the contact angle of the cleaning liquid to the SUS304 plate is not particularly limited, and may be 10 degrees or more, for example.

The contact angle of the cleaning liquid to the SUS304 plate can be adjusted by changing the type of the surfactant C and the content ratio of the glycol ether, for example. When the surfactant C is an acetylene surfactant or a silicone surfactant, the contact angle of the cleaning liquid to the SUS304 plate can be easily adjusted to no greater than 40 degrees. Furthermore, when containing glycol ether at a content ratio of no greater than 15% by mass relative to the mass of the cleaning liquid, the contact angle of the cleaning liquid to the SUS304 plate can easily be adjusted to no greater than 40 degrees. The measurement method of the contact angle of the cleaning liquid to the SUS304 plate is described later in Example.

(Viscosity of Cleaning Liquid)

The viscosity of the cleaning liquid at 25° C. is preferably no greater than 10.0 mPa·s, and more preferably no greater than 5.0 mPa·s. In the following, the “viscosity of the cleaning liquid at 25° C.” may be referred to as the “viscosity of the cleaning liquid”. When the viscosity of the cleaning liquid is no greater than 10.0 mPa·s, it is difficult to wipe the cleaning liquid off when using the cleaning liquid to clean the ejection surface. The lower limit of the viscosity of the cleaning liquid is not particularly limited, and may be at least 1.0 mPa·s, for example. The viscosity of the cleaning liquid can be adjusted by changing the content ratio of the glycol ether or the content ratio of the water-soluble organic solvent C. The lower the content ratio of the glycol ether, the lower the viscosity of the cleaning liquid. The measurement method of the viscosity of the cleaning liquid is described later in Example.

(Surfactant C)

When the cleaning liquid contains the surfactant C, the contact angle of the cleaning liquid to the SUS304 plate is reduced to a desired value, which increases wettability. The surfactant C functions as a wetting agent to increase wettability to the SUS304 plate, for example.

The surfactant C is an acetylene surfactant or a silicone surfactant. An acetylene surfactant and a silicone surfactant facilitate reduction of the contact angle of the cleaning liquid to a desired value as compared to other surfactants (e.g., a coconut oil fatty acid surfactant). The cleaning liquid preferably does not contain a coconut oil fatty acid surfactant as the surfactant C.

In the present specification, an acetylene surfactant refers to a surfactant with an acetylene bond (triple bond between carbon atoms). The acetylene surfactant preferably has a moiety represented by the following formula (1). In formula (1), R¹ represents a group including a hydroxy group and * represents an atomic bonding.

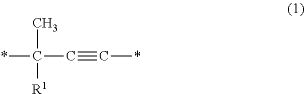

The atomic bonding represented by * in formula (1) is bonded to an atom included in the acetylene surfactant (e.g., a hydrogen atom or a carbon atom).

Examples of a group including the hydroxy group represented by R¹ in formula (1) include a hydroxy group and a group to which ethylene oxide is added. The group to which ethylene oxide is added is preferably the group represented by formula (2). In formula (2), m represents the number of moles of ethylene oxide added. For example, m is an integer equal to or greater than 1. In formula (2), * represents an atomic bonding, and this atomic bonding is bonded to the carbon atom to which R¹ in formula (1) is bonded.

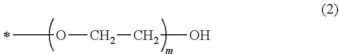

Examples of the acetylene surfactant include acetylene alcohol, acetylene glycol, and an ethylene oxide adduct of acetylene glycol. The acetylene alcohol preferably has a moiety represented by formula (1A). The acetylene glycol preferably has a moiety represented by formula (1B). The ethylene oxide adduct of acetylene glycol is preferably a compound represented by formula (1C).

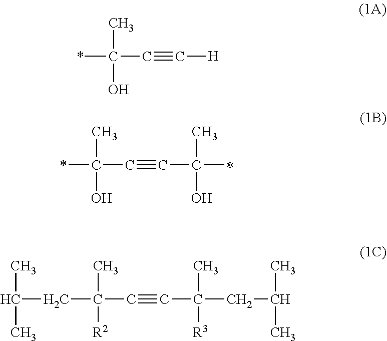

In formulas (1A) and (1B), * represents an atomic bonding, and the atomic bonding is bound to a carbon atom included in the acetylene surfactant. In formula (1C), R² and R³ represent groups to which the previously described ethylene oxide has been added.

In the present specification, a silicone surfactant refers to a surfactant with a siloxane bond. The silicone surfactant is preferably polyether-modified silicone, and more preferably polyether-modified polydimethylsiloxane. The polyether-modified polydimethylsiloxane preferably has a repeating unit represented by formula (3), and more preferably has the repeating unit represented by formula (3) and a terminal group represented by formula (4).

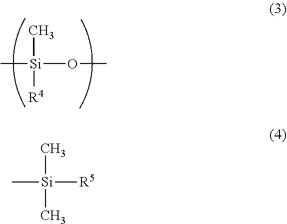

R⁴ in formula (3) and R⁵ in formula (4) each independently represent a methyl group or a polyether group. However, at least one of R⁴ and R⁵ represent a polyether group. The polyether group is a group containing one or both of —C₂H₄O— and —C₃H₆O—.

The surfactant C is preferably a nonionic surfactant. The HLB value of the surfactant C is preferably at least 3 and no greater than 20, more preferably at least 6 and no greater than 16, even more preferably at least 8 and no greater than 14, and particularly preferably at least 9 and no greater than 14. Furthermore, the HLB value of the surfactant C may be at least 8 and no greater than 10, greater than 10 and no greater than 12, or greater than 12 and no greater than 14.

The dynamic surface tension of a 0.1% by mass aqueous solution of the surfactant C is preferably at least 20 mN/m and no greater than 50 mN/m, and more preferably at least 25 mN/m and no greater than 40 mN/m.

The cleaning liquid may further contain a surfactant other than the surfactant C. An example of a surfactant other than the surfactant C is the same as an example of a surfactant I described later in the second embodiment.

In order to adjust the contact angle of the cleaning liquid to a value within a desired range, the content ratio of the surfactant C is preferably no greater than 1.0% by mass relative to the mass of the cleaning liquid. For the same reason, the content ratio of the surfactant C is preferably greater than 0.0% by mass relative to the mass of the cleaning liquid, more preferably at least 0.5% by mass, even more preferably at least 0.6% by mass, and yet more preferably at least 0.7% by mass.

(Glycol Ether)

The glycol ether can swell the pigment dispersion resin and the binder resin contained in the ink while being compatible with the cleaning liquid containing water.

Examples of the glycol ether contained in the cleaning liquid include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, propylene glycol monomethyl ether, and dipropylene glycol monomethyl ether.

The glycol ether contained in the cleaning liquid is preferably alkylene glycol alkyl ether, more preferably alkylene glycol alkyl ether with at least 3 and no more than 11 carbon atoms, even more preferably alkylene glycol alkyl ether with at least 5 and no more than 10 carbon atoms, and yet more preferably triethylene glycol monobutyl ether, diethylene glycol monoethyl ether, or dipropylene glycol monomethyl ether.

As previously described, the content ratio of the glycol ether is at least 5% by mass and no greater than 15% by mass relative to the mass of the cleaning liquid. When the content ratio of the glycol ether is no greater than 15% by mass relative to the mass of the cleaning liquid, movement of the surfactant C to the gas-liquid interface between the atmosphere and the cleaning liquid is hardly hindered by the glycol ether. If the surfactant C moves to the gas-liquid interface, the contact angle of the cleaning liquid to the nozzle inner surface and the proximate area surface can be easily reduced to a desired value. When the content ratio of the glycol ether is at least 5% by mass relative to the mass of the cleaning liquid, plasticity is imparted to the pigment dispersion resin and the binder resin contained in the stuck ink, and the stuck ink is easily swollen.

(Water)

The water in the cleaning liquid is ion exchange water, for example. The content ratio of the water is preferably at least 50% by mass and no greater than 95% by mass relative to the mass of the cleaning liquid, and more preferably at least 70% by mass and no greater than 85% by mass.

(Water-Soluble Organic Solvent C)

The water-soluble organic solvent C is a water-soluble organic solvent other than glycol ether. Examples of the water-soluble organic solvent C include a glycol compound, a lactam compound, a nitrogen-containing compound, an acetate compound, thiodiglycol, glycerin, and dimethyl sulfoxide.

Examples of the glycol compound include ethylene glycol, 1,2-propanediol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the lactam compound include 2-pyrrolidone and N-methyl-2-pyrrolidone.

Examples of the nitrogen-containing compound include 1,3-dimethylimidazolidinone, formamide, and dimethyl formamide.

Examples of the acetate compound include diethylene glycol monoethyl ether acetate.

The water-soluble organic solvent C is preferably glycerin or a glycol compound, and more preferably glycerin, 1,2-propanediol, 1,3-propanediol, or diethylene glycol.

In order to adjust the viscosity of the cleaning liquid to a value within a desired range and inhibit the occurrence of unwiped cleaning liquid, the content ratio of the water-soluble organic solvent C is preferably at least 1% by mass and no greater than 30% by mass relative to the mass of the cleaning liquid, and more preferably at least 5% by mass and no greater than 20% by mass. When the content ratio of the water-soluble organic solvent C is no greater than 30% by mass relative to the mass of the cleaning liquid, the viscosity of the cleaning liquid is easily adjusted to a value no greater than 10.0 mPa·s.

(Other Components)

The cleaning liquid may further contain known additives (more specifically, a solution stabilizer, an anti-drying agent, an antioxidant, a viscosity modifier, a pH adjuster, and an antifungal agent) as necessary.

(Production Method of Cleaning Liquid)

The cleaning liquid of the first embodiment is produced, for example, by mixing water, the surfactant C, glycol ether, and additional components as necessary using a stirrer.

(Cleaning Method Using Cleaning Liquid)

By supplying the cleaning liquid of the first embodiment to the ejection surface of the recording head, the nozzle inner surface, the proximate area surface, and parts of the ejection surface other than the proximate area surface are cleaned. Examples of the method of supplying the cleaning liquid to the ejection surface include supplying the cleaning liquid using a sponge or a sheet impregnated with the cleaning liquid, ejecting the cleaning liquid using an inkjet method, applying the cleaning liquid using a roller, and spraying the cleaning liquid. After supplying the cleaning liquid, the ejection surface is preferably wiped using a wiping blade, for example. Note that the cleaning liquid of the first embodiment can also be used to wash members (e.g., a wiping blade and a conveyance roller) included in the inkjet recording apparatus other than the recording head.

### Second Embodiment: Inkjet Recording Apparatus Liquid Set

A second embodiment of the present disclosure relates to an inkjet recording apparatus liquid set (may be referred to below as a liquid set). The liquid set according to the second embodiment includes a first liquid and a second liquid. The first liquid is an ink. The second liquid is the cleaning liquid according to the first embodiment.

<Ink>

The following describes the ink which is the first liquid included in the liquid set of the second embodiment. The ink is a water-based ink containing water. The ink contains pigment particles and water. The ink preferably further contains a first resin (pigment dispersion resin) attached to the surfaces of the pigment particles. The ink also preferably further contains a second resin (binder resin) in the form of emulsified particles. The ink may further contain a surfactant, a water-soluble organic solvent, and other components as necessary. In the following, a “surfactant contained in the ink” and a “water-soluble organic solvent contained in the ink” may be respectively referred to as a “surfactant I” and a “water-soluble organic solvent I”.

(Pigment Particles)

Examples of the pigment constituting the pigment particles include yellow pigments, orange pigments, red pigments, blue pigments, violet pigments, and black pigments. Examples of the yellow pigments include C.I. Pigment Yellow 74, 93, 95, 109, 110, 120, 128, 138, 139, 151, 154, 155, 173, 180, 185, and 193. Examples of the orange pigments include C.I. Pigment Orange 34, 36, 43, 61, 63, and 71. Examples of the red pigments include C.I. Pigment Red 122 and 202. Quinacridone/magenta (PR 122) may be used as a red pigment. Examples of the blue pigments include C.I. Pigment Blue 15 and 15:3. Examples of the violet pigments include C.I. Pigment Violet 19, 23, and 33. Examples of the black pigments include C.I. Pigment Black 4 and 7. Carbon black may be used as a black pigment.

The content ratio of the pigment particles is preferably at least 1% by mass and no greater than 8% by mass relative to the mass of the ink, and more preferably at least 1% by mass and no greater than 5% by mass. When the content ratio of the pigment particles is at least 1% by mass relative to the mass of the ink, an image with a desired image density is easily obtained. When the content ratio of the pigment particles is no greater than 8% by mass relative to the mass of the ink, the fluidity of the ink is easily ensured. Through the above, an image with a desired image density is also easily obtained. Furthermore, the permeability of the ink to a recording medium is easily ensured.

To obtain an ink with excellent color density and hue, the volume median diameter (D50) of the pigment particles is preferably at least 30 nm and no greater than 200 nm, and more preferably at least 70 nm and no greater than 130 nm.

(First Resin)

The first resin is a pigment dispersion resin. The first resin is attached to the surfaces of the pigment particles. The first resin is attached to the surfaces of the pigment particles and functions as a dispersant which disperses the pigment particles in the ink. Note that a portion of the first resin may be free in the ink and not attached to the surfaces of the pigment particles.

Examples of the first resin include an acrylic resin, a styrene-acrylic resin, a polyvinyl resin, a polyester resin, an amino resin, an epoxy resin, a urethane resin, a polyether resin, a polyamide resin, a phenolic resin, a silicone resin, a fluororesin, a styrene-maleic acid copolymer, a styrene-maleic acid half ester copolymer, a vinylnaphthalene-acrylic acid copolymer, and a vinylnaphthalene-maleic acid copolymer. The first resin is preferably an acrylic resin or a styrene-acrylic resin, and more preferably a styrene-acrylic resin.

The acrylic resin is a polymer of (meth)acrylic acid or alkyl (meth)acrylate.

The styrene-acrylic resin is a copolymer of styrene and at least one selected from the group consisting of (meth)acrylic acid and alkyl (meth)acrylate. The styrene-acrylic resin is preferably a copolymer of styrene, (meth)acrylic acid, and alkyl (meth)acrylate. The styrene-acrylic resin is more preferably a copolymer of styrene, (meth)acrylic acid, and alkyl (meth)acrylate in which the number of carbon atoms of an alkyl group is at least 1 and no more than 4. The styrene-acrylic resin is particularly preferably a copolymer of styrene, methacrylic acid, methyl methacrylate, and butyl acrylate.

The first resin is preferably anionic. When the first resin is anionic, the first resin may form a salt (e.g., a sodium salt or a potassium salt).

The mass average molecular weight (Mw) of the first resin is preferably at least 5,000 and no greater than 100,000, and more preferably at least 15,000 and no greater than 25,000. The acid value of the first resin is preferably at least 50 mg KOH/g and no greater than 150 mg KOH/g, and more preferably at least 90 mg KOH/g and no greater than 110 mg KOH/g.

The content ratio of the first resin is preferably at least 15% by mass and no greater than 100% by mass relative to the mass of the pigment particles, and more preferably at least 20% by mass and no greater than 50% by mass. When the content ratio of the first resin is at least 15% by mass relative to the mass of the pigment particles, strike through hardly occur in a formed image. When the content ratio of the first resin is no greater than 100% by mass relative to the mass of the pigment particles, an image with a desired image density is easily obtained.

The content ratio of the first resin is preferably at least 0.1% by mass and no greater than 3.0% by mass relative to the mass of the ink, and more preferably at least 0.1% by mass and no greater than 1.5% by mass. When the content ratio of the first resin is at least 0.1% by mass relative to the mass of the ink, an ink with excellent preservation stability and ejection stability is easily obtained. When the content ratio of the first resin is no greater than 3.0% by mass relative to the mass of the ink, white space in the formed image is easily inhibited.

(Second Resin)

The second resin is a binder resin which binds the ink to the recording medium. The second resin is a different resin from the first resin. When the ink contains the second resin, the second resin is contained in the ink in emulsified particle form. That is, emulsified particles composed of the second resin are dispersed in the ink.

Examples of the second resin include a thermoplastic resin. Examples of the thermoplastic resin include an acrylic resin, a styrene-acrylic resin, a polyester resin, polyurethane, and polyolefin. The second resin is preferably an acrylic resin, polyurethane, or polyolefin so that the second resin is suitably emulsified and dispersed in the ink and the ink suitably adheres to the recording medium.

When the prescribed recording medium is used as the recording medium, the content ratio of the second resin is preferably at least 0.9% by mass and no greater than 3.0% by mass relative to the mass of the ink. When the content ratio of the second resin is no greater than 3.0% by mass relative to the mass of the ink, the cleaning liquid easily cleans the ink and ejection failure and ejection defects of the ink hardly occur. When the content ratio of the second resin is at least 0.9% by mass relative to the mass of the ink, the ink easily adheres to the prescribed recording medium. Examples of a low-absorbency recording medium of the prescribed recording medium include art paper, coated paper, and cast-coated paper. Examples of a non-absorbent recording medium of the prescribed recording medium include foil paper, synthetic paper, and a plastic base material. Examples of the plastic base material include a polyester (PET) base material, a polypropylene base material, a polystyrene base material, and a polyvinyl chloride base material.

When a recording medium (e.g., plain paper) other than the prescribed recording medium is used as the recording medium, the content ratio of the second resin is preferably greater than 0.0% by mass and less than 0.9% by mass. When a recording medium other than the prescribed recording medium is used as the recording medium and the adhesion of the ink to the recording medium is ensured, the ink need not contain the second resin. Examples of a recording medium other than the prescribed recording medium include plain paper and fine paper.

(Water)

The water in the ink is ion exchange water, for example. To obtain an ink with excellent ejection stability, the content ratio of the water is preferably at least 30% by mass and no greater than 80% by mass relative to the mass of the ink, and more preferably at least 50% by mass and no greater than 65% by mass.

(Water-Soluble Organic Solvent I)

Examples of the water-soluble organic solvent I contained in the ink include a solvent exemplified by the water-soluble organic solvent C and a solvent exemplified by glycol ether. Preferable examples of the water-soluble organic solvent I include glycol ether and a glycol compound. More preferable examples of the water-soluble organic solvent I include triethylene glycol monobutyl ether and 1,2-propanediol.

To obtain an ink with excellent ejection stability, the content ratio of the water-soluble organic solvent I is preferably at least 10% by mass and no greater than 65% by mass relative to the mass of the ink, and more preferably at least 15% by mass and no greater than 30% by mass.

(Surfactant I)

When the ink contains the surfactant I, the wettability of the ink to the recording medium improves. Examples of the surfactant I include an anionic surfactant, a cationic surfactant, and a nonionic surfactant. The surfactant I is preferably a nonionic surfactant.

Examples of the nonionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and an ethylene oxide adduct of acetylene glycol. The nonionic surfactant is preferably an ethylene oxide adduct of acetylene glycol.

The HLB value of the surfactant I is preferably at least 3 and no greater than 20, more preferably at least 6 and no greater than 16, and further preferably at least 7 and no greater than 9.

The dynamic surface tension of a 0.1% by mass aqueous solution of the surfactant I is preferably at least 20 mN/m and no greater than 50 mN/m, and more preferably at least 30 mN/m and no greater than 35 mN/m.

(Other Components)

The ink may further contain known additives (more specifically, for example, a solution stabilizer, an anti-drying agent, an antioxidant, a viscosity modifier, a pH adjuster, and an antifungal agent) as necessary.

(Production Method of Ink)

The production method of the ink includes a pigment dispersion preparation process and a pigment dispersion and other ink component mixing process, for example.

In the pigment dispersion preparation process, the pigment particles, water, and the first resin as necessary are kneaded using a disperser (e.g., a media-type disperser) to obtain the pigment dispersion.

In the mixing process, the pigment dispersion and other ink components (e.g., the second resin, water, the water-soluble organic solvent I, and the surfactant I) are mixed together using a stirrer to obtain the ink. The ink that is the first liquid included in the liquid set of the second embodiment is described above.

### Example

Example of the present disclosure is described. Note that in evaluations in which errors occurred, an equivalent number of measurement values in which an error was sufficiently small was obtained, and the arithmetic mean of the obtained measurement values was used as an evaluation value. Furthermore, in the following description, “water” refers to “ion exchange water”.

[Preparation of Cleaning Liquid]

Cleaning liquid s (CA-1) to (CA-11) according to Example and cleaning liquid s (CB-1) to (CA-3) according to Comparative Example were prepared. Components and blending amounts thereof contained in these cleaning liquid s are shown in Tables 2 to 5 below.

<Preparation of Cleaning Liquid (CA-1)>

First, 1 part by mass of a surfactant S1 (silicone surfactant, “Silface SGA503A”, product of Nissin Chemical Industry Co., Ltd), 10 parts by mass of 1,2-propanediol, 10 parts by mass of triethylene glycol monobutyl ether, and a remaining amount of water were added to a beaker. Note that a remaining amount refers to an amount such that the total amount of components contained in the cleaning liquid was 100 parts by mass. In the preparation of the cleaning liquid (CA-1), the remaining amount of water was 79 parts by mass of water. The contents of the beaker were stirred at a rotational speed of 400 rpm using a stirrer (“Three-One Motor BL-600”, product of Shinto Scientific Co., Ltd.) until the contents of the beaker were uniform. Through the above, the cleaning liquid (CA-1) was obtained.

<Preparation of Cleaning Liquids (CA-2) to (CA-11) and (CB-1) to (CB-3)>

Cleaning liquid s (CA-2) to (CA-11) and (CB-1) to (CB-3) were prepared by the same method as that of the cleaning liquid (CA-1) except that components shown in Tables 2 to 5 were used in blending amounts thereof shown in Tables 2 to 5.

[Preparation of Pigment Dispersion]

Pigment dispersions (C), (Y), (M), and (BK) were prepared for use in the preparation of the ink. Components and blending amounts thereof contained in each of these pigment dispersions are shown in Table 1.

TABLE 1

| Pigment dispersion | | C | Y | M | BK |
|---|---|---|---|---|---|
| Blending amount | Water | 80 | 80 | 80 | 80 |
| (% by mass) | Resin A-Na | 5 | 5 | 5 | 5 |
| | Cyan pigment | 15 | — | — | — |
| | Yellow pigment | — | 15 | — | — |
| | Magenta pigment | — | — | 15 | — |
| | Black pigment | — | — | — | 15 |
| | Total | 100 | 100 | 100 | 100 |

Terms used in Table 1 are defined below.
Cyan pigment: C.I. Pigment Blue 15:3
Yellow pigment: C.I. Pigment Yellow 74
Magenta pigment: C.I. Pigment Red 122
Black pigment: C.I. Pigment Black 4
Resin A-Na: Resin A neutralized with sodium hydroxide (NaOH)

<Preparation of Resin A>

To obtain the “Resin A-Na” in Table 1, the resin A was prepared by the following method. In detail, a stirrer bar, a nitrogen inlet tube, a condenser (stirrer), and a dropping funnel were set in a four-necked flask. Next, 100 parts by mass of isopropyl alcohol and 300 parts by mass of methyl ethyl ketone were added to the flask. Heating reflux was performed at 70° C. while bubbling nitrogen into the flask contents.

Next, a solution L1 was prepared. In detail, the solution L1, which was a monomer solution, was obtained by mixing 40.0 parts by mass of styrene, 10.0 parts by mass of methacrylic acid, 40.0 parts by mass of methyl methacrylate, 10.0 parts by mass of butyl acrylate, and 0.4 parts by mass of azobisisobutyronitrile (AIBN, polymerization initiator). In a state where the flask contents were heat refluxed at 70° C., the solution L1 was dropped into the flask over 2 hours. After dropping, the flask contents where heat refluxed at 70° C. for another 6 hours.

Next, a solution L2 was prepared. In detail, 0.2 parts by mass of AIBN was mixed with methyl ethyl ketone to obtain the solution L2. The solution L2 was dropped into a flask over 15 minutes. After dropping, the flask contents were heat refluxed at 70° C. for another 5 hours. Through the above, the resin A (styrene-acrylic resin) was obtained. In the obtained resin A, the mass average molecular weight (Mw) was 20,000 and the acid value was 100 mg KOH/g.

Here, the mass average molecular weight Mw of the resin A was measured using gel filtration chromatography (“HLC-8020 GPC”, product of Tosoh Corporation) under the following conditions.

Column: “TSKgel SuperMultipore HZ-H”, product of Tosoh Corporation (4.6 mm I.D.×15 cm semi-microcolumn)

Number of columns: 3

Eluent: tetrahydrofuran

Flow rate: 0.35 mL/minute

Sample injection volume: 10 μL

Measurement temperature: 40° C.

Detector: IR detector

A calibration curve was prepared by selecting n-propylbenzene and 7 types of TSKgel standard polystyrene produced by Tosoh Corporation: F-40, F-20, F-4, F-1, A-5000, A-2500, and A-1000.

The acid value of the resin A was measured by a method in accordance with “JIS (Japanese Industrial Standard) K 0070-1992 (Test methods for acid value, saponification value, ester value, iodine value, hydroxyl value and unsaponifiable matter of chemical products)”.

<Preparation of Pigment Dispersion (C)>

An amount of sodium hydroxide aqueous solution necessary to neutralize the resin A was added to the resin A while heating the resin A in a warm bath at 70° C. More specifically, an amount of sodium hydroxide aqueous solution 1.1 times the neutralization equivalent was added to the resin A. Through the above, an aqueous solution of the resin A (resin A-Na) neutralized with sodium hydroxide was obtained. The pH of the aqueous solution of the resin A-Na was 8.

So as to obtain the blending amounts shown in Table 1, 5 parts by mass of the resin A-Na, 15 parts by mass of C.I. Pigment Blue 15:3, and 80 parts by mass of water were added to the vessel (capacity: 1.4 L) of a media-type disperser (“DYNO (registered Japanese trademark) Mill”, product of Willy A. Bachofen (WAB) AG). Note that water was added so that the mass of water was 80 parts by mass, including the mass of water included in the sodium hydroxide aqueous solution used to neutralize the resin A and the mass of water generated by the neutralization reaction.

Next, media (zirconia beads with a diameter of 1.0 mm) were filled into the vessel so that the filling ratio was 70% by volume relative to the capacity of the vessel. Dispersion processing was performed on the vessel contents using the media-type disperser. Through the above, a pigment dispersion (C) was obtained which was a pigment dispersion for cyan ink.

Water was used to dilute the pigment dispersion (C) 300 times to obtain a dilution. The dilution was measured using a dynamic light scattering type particle size distribution analyzer (“ZETASIZER Nano ZS”, product of Sysmex Corporation) and the volume median diameter (D50) of the pigment particles contained in the pigment dispersion (C) was determined. It was then confirmed that pigment particles with a volume median diameter within a range of at least 70 nm and no greater than 130 nm were dispersed in the pigment dispersion (C).

<Preparation of Pigment Dispersions (Y), (M), and (BK)>

The pigment dispersions (Y), (M), and (BK) were prepared by the same method as that of the pigment dispersion (C) except that components shown in Table 1 were used in blending amounts thereof shown in Table 1. The pigment dispersions (Y), (M), and (BK) were pigment dispersions for yellow ink, magenta ink, and black ink, respectively.

[Preparation of Ink]

Inks (I-1) through (I-5) were prepared for use in the liquid set. Components and blending amounts thereof contained in these inks are shown below in Tables 2 to 5.

<Preparation of Ink (I-1)>

The ink (I-1) encompassed four color inks (I-1), that is, a cyan ink (I-1), a yellow ink (I-1), a magenta ink (I-1), and a black ink (I-1). In the following, the four color inks (I-1) may be collectively referred to as an “ink (I-1)”.

(Preparation of Cyan Ink (I-1))

To reach the blending amounts listed in the “Ink (I-1)” column of Table 2, the components were added to a beaker. In detail, the remaining amount of water, 15 parts by mass of the pigment dispersion (C), 5 parts by mass of a resin emulsion R1, 1 part by mass of a surfactant A3, 10 parts by mass of 1,2-propanediol, and 10 parts by mass of triethylene glycol monobutyl ether were added to the beaker. The remaining amount was an amount such that the total mass of the components contained in the ink was 100 parts by mass, and was 59 parts by mass in the preparation of the cyan ink (I-1). The contents of the beaker were mixed at a rotational speed of 400 rpm using a stirrer (“Three-One Motor BL-600”, product of Shinto Scientific Co., Ltd.) to obtain a mixed solution. The mixed solution was filtered using a filter (pore diameter 5 μm) to remove foreign matter and coarse particles contained in the mixed solution. Through the above, the cyan ink (I-1) was obtained.

(Preparation of Yellow Ink (I-1), Magenta Ink (I-1), and Black Ink (I-1))

The yellow ink (I-1) was prepared by the same method as that of the cyan ink (I-1) except that the pigment dispersion (C) was changed to a pigment dispersion (Y). The magenta ink (I-1) was prepared by the same method as that of the cyan ink (I-1) except that the pigment dispersion (C) was changed to a pigment dispersion (M). The black ink (I-1) was prepared by the same method as that of the cyan ink (I-1) except that the pigment dispersion (C) was changed to a pigment dispersion (BK).

<Preparation of Ink (I-2)>

Four color inks (I-2) were prepared by the same method as that of the four color inks (I-1) except that components shown in the “Ink (I-2)” column of Table 3 were used in blending amounts thereof shown in the same column. In the following, the four color inks (I-2) may be collectively referred to as an “ink (I-2)”.

<Preparation of Ink (I-3)>

Four color inks (I-3) were prepared by the same method as that of the four color inks (I-1) except that components shown in the “Ink (I-3)” column of Table 3 were used in blending amounts thereof shown in the same column. In the following, the four color inks (I-3) may be collectively referred to as an “ink (I-3)”.

<Preparation of Ink (I-4)>

Four color inks (I-4) were prepared by the same method as that of the four color inks (I-1) except that components shown in the “Ink (I-4)” column of Table 4 were used in blending amounts thereof shown in the same column. In the following, the four color inks (I-4) may be collectively referred to as an “ink (I-4)”.

<Preparation of Ink (I-5)>

Four color inks (I-5) were prepared by the same method as that of the four color inks (I-1) except that components shown in the “Ink (I-5)” column of Table 4 were used in blending amounts thereof shown in the same column. In the following, the four color inks (I-5) may be collectively referred to as an “ink (I-5)”.

[Measurement]

<Measurement of Viscosity of Cleaning Liquid>

The viscosity of the cleaning liquid was measured by a method in accordance with “JIS Z 8803:2011 (Methods for viscosity measurement of liquid)” under a 25° C. environment. The measurement results are shown in Tables 2 to 5.

<Measurement of Contact Angle of Cleaning Liquid>

Under a 25° C. environment, the cleaning liquid was dropped into the SUS304 plate using a contact angle measuring device (“OCA 40”, product of EKO Instruments B.V.) and the contact angle of a droplet of the cleaning liquid on the SUS304 plate was measured 1 second after the cleaning liquid landed on the SUS304 plate. A SUS304 plate (0.05 mm thick, 300 mm long, and 200 mm wide, product of OEM Corporation) was cut into a 5 mm long and 5 mm wide piece and used as the SUS304 plate. The measurement results are shown in Tables 2 to 5.

[Evaluation]

In the following evaluation, an inkjet recording apparatus (prototype machine produced by KYOCERA Document Solutions Inc.) including four recording heads was used as an evaluation apparatus. The four recording heads were piezoelectric lineheads with 2,656 nozzles each. The droplet volume was set at 10 pL and the drive frequency was set at 20 kHz.

The inks (four color inks) listed in Tables 2 to 5 were each filled into an ink tank of the corresponding color and the ejection surface of each recording head was cleaned using the cleaning liquid s listed in Tables 2 to 5. For example, in the evaluation of Example 1, the inks (I-1) listed in Table 2 (i.e., the four color inks: cyan ink (I-1), yellow ink (I-1), magenta ink (I-1), and black ink (I-1)) were each filled into the corresponding color ink tanks and the ejection surfaces of the recording heads were cleaned using the cleaning liquid (CA-1) listed in Table 2.

<Evaluation of Cleanability>

The cleanability of the ejection surfaces of the recording heads was evaluated under normal temperature and humidity (a temperature of 25° C. and a humidity of 60% RH). Using the evaluation apparatus, a solid image (100% printing rate, A4 size) was continuously printed on 5,000 sheets of paper (“P”, product of Xerox Corporation). After printing, a purge operation, a first cleaning liquid supply operation, a first wiping operation, a second cleaning liquid supply operation, and a second wiping operation were performed. In the purge operation, ink was purged from each of the four recording heads. In the cleaning liquid supply operations, a sheet (“BEMCOT (registered Japanese trademark) M-311”, product of Asahi Kasei Corp., cut to the same size as the ejection surface) soaked with 3 mL of the cleaning liquid was brought into contact with the ejection surface of each of the four recording heads for 30 seconds. In the wiping operations, a wiping blade included in the evaluation apparatus was used to wipe the ejection surface of each of the four recording heads. The ejection surfaces were observed at an observation magnification of 50× using a microscope to confirm the presence or absence of residual ink that could not be cleaned. The cleanability of the ink was determined according to the following criteria. The determination results are shown in Tables 2 to 5.

(Evaluation Criteria of Cleanability)

A (particularly good): No ink attached to the ejection surface.

B (good): A minute amount of ink attached to the ejection surface.

C (poor): A considerable amount of ink attached to the ejection surface.

<Evaluation of Accuracy of Ink Placement>

The accuracy of ink placement was evaluated under normal temperature and humidity (temperature of 25° C. and humidity of 60% RH). First, using the evaluation apparatus which previously implemented the above <Evaluation of cleanability>, a drop of ink was ejected from all nozzles of the four recording heads to form a row of dots on 1 sheet of paper (“C²”, product of Fuji Xerox Co., Ltd., A4-size plain paper). The paper on which the row of dots was formed was set as first evaluation paper. Next, a row of dots was formed in the same manner using the evaluation apparatus which previously implemented the above <Evaluation of cleanability>, and the paper on which the row of dots was formed was set as second evaluation paper.

An image analysis device (“High-speed high-definition image processing and analysis system Dot Analyzer DA-6000”, product of Oji Scientific Instruments Co., Ltd.) was used to observe the first evaluation paper and the second evaluation paper and confirm any artifacts in the rows of dots. More specifically, a width of displacement in the horizontal direction of each evaluation paper and a width of displacement in the vertical direction of each evaluation paper was determined for all 2,656 dots of cyan ink, all 2,656 dots of yellow ink, all 2,656 dots of magenta ink, and all 2,656 dots of black ink formed on the evaluation paper. From the measurement results, an average value (3σx, unit: μm) of displacement widths in the horizontal direction of each evaluation paper and an average value (3σx, unit: μm) of displacement widths in the vertical direction of each evaluation paper was calculated. Then, from the calculation formula “3σ=3√[(σx)²+(σy)²]”, a displacement width 3σ (unit: μm) of the rows of dots formed on each evaluation paper was calculated. Then, from the calculation formula “Δ3σ=|(3σ of first evaluation paper)−(3σ of second evaluation paper)|”, an amount of change Δ3σ (unit: μm) in the displacement width of the rows of dots before and after printing 5000 sheets was calculated. The accuracy of ink placement was determined according to the following criteria. The determination results are shown in Tables 2 to 5. Note that according to the evaluation of accuracy of ink placement, the presence or absence of stuck ink even finer than that in the above <Evaluation of cleanability> could be confirmed. The better the accuracy of ink placement, the better the stuck ink on the nozzle inner surface and the proximate area surface tended to be cleaned.

(Evaluation Criteria of Accuracy of Ink Placement)

A (good): The amount of change Δ3σ was less than 3 μm.

B (poor): The amount of change Δ3σ was 3 μm or greater.

<Evaluation of Adhesion>

Using the evaluation apparatus, a solid image (100% printing rate) was printed on a PET sheet (polyester film, “LUMIRROR (registered Japanese trademark) S10 #50”, product of Toray Industries, Inc.). The printed sheet was heated at 120° C. for 30 seconds to dry the ink. The obtained sheet was used as an evaluation sheet. On the image on the evaluation sheet, 6 grid (square-shaped) cuts with 2 mm intervals were made vertically and horizontally to form 25 square cells measuring 2 mm on each side. Twenty five cells were formed in 4 locations for a total of 100 cells. Adhesive tape (“CELLOTAPE (registered Japanese trademark) CT-24”, product of NICHIBAN Co., Ltd.) was applied over the cut image, and the adhesive tape was peeled off at an angle of approximately 60 degrees. The adhesive tape was peeled at a speed such that the time from the start of peeling to the end of peeling was 1 second. After the adhesive tape was peeled off, the peeled surface on the evaluation sheet was observed and the number of cells that remained unpeeled was counted. The adhesion of the ink was determined according to the following criteria. The determination results are shown in Tables 2 to 5.

(Evaluation Criteria of Adhesion)

A (good): The persistence of the cells was at least 90%.

B (poor): The persistence of the cells was less than 90%.

The terms listed in Tables 2 to 5 are defined below.

Pigment dispersion: Pigment dispersion obtained in the above [Preparation of pigment dispersion].

Resin emulsion R1: Emulsion of polyurethane (“ETERNACOLL (registered Japanese trademark) UW-5002E”, product of Ube Industries, Ltd., solid concentration: 30% by mass, dispersion medium: water).

Resin emulsion R2: Emulsion of acrylic resin (“MOWINYL (registered Japanese trademark) 6820”, product of Japan Coating Resin Corporation, solid concentration: 45% by mass, dispersion medium: water).

Resin emulsion R3: Emulsion of modified polyolefin (“APTOLOK BW-5635”, product of Mitsubishi Chemical Corporation, solid concentration: 30% by mass, dispersion medium: water).

Surfactant S1: Silicone surfactant (“Silface SGA503A”, product of Nissin Chemical Industry Co., Ltd, active component: polyether-modified polydimethylsiloxane, active component concentration: 100% by mass, ionicity: nonionic surfactant, HLB value: 11, dynamic surface tension of 0.1% by mass aqueous solution: 37 mN/m).

Surfactant S2: Silicone surfactant (“BYK-3450”, product of BYK Japan, active component: polyether-modified polydimethylsiloxane, active component concentration: 100% by mass).

Surfactant A1: Acetylene surfactant (“OLFINE (registered Japanese trademark) E1010”, product of Nissin Chemical Industry Co., Ltd., active component concentration: 100% by mass, ionicity: nonionic surfactant, HLB value: 13.5, dynamic surface tension of 0.1% by mass aqueous solution: 39 mN/m).

Surfactant A2: Acetylene surfactant (“OLFINE (registered Japanese trademark) EXP4300”, product of Nissin Chemical Industry Co., Ltd., active component concentration: 60% by mass, solvent: propylene glycol and dipropylene glycol, ionicity: nonionic surfactant, dynamic surface tension of 0.1% by mass aqueous solution: 26 mN/m).

Surfactant A3: Acetylene surfactant (“SURFYNOL (registered Japanese trademark) 440”, product of Nissin Chemical Industry Co., Ltd., active component: ethylene oxide adduct of acetylene glycol, active component concentration: 100% by mass, ionicity: nonionic surfactant, HLB value: 8, dynamic surface tension of 0.1% by mass aqueous solution: 32 mN/m).

Surfactant X: Coconut oil fatty acid amidopropyl betaine (“AMOGEN (registered Japanese trademark) CB-H”, product of DKS Co. Ltd., ionicity: zwitterionic surfactant, solid concentration: 30% by mass).

-: No applicable components were used.

Remaining amount: An amount such that the total mass of the components contained in the ink or the cleaning liquid was 100 parts by mass. For example, the amount of water contained in the ink (I-1) was 59 parts by mass (=100−(15+5+1+10+10)). For another example, the amount of water contained in the cleaning liquid (CA-1) was 79 parts by mass (=100−(1+10+10)).

Viscosity: Viscosity of cleaning liquid (unit: mPa·s).

Contact angle: Contact angle of cleaning liquid to SUS304 plate (unit: degree).

NG: Poor.

In the columns of the resin emulsions R1 to R3 in Tables 2 to 5, numbers without brackets indicate the blending amount of liquid (unit: % by mass) in the resin emulsion, and numbers with brackets indicate the amount of solid content in the resin emulsion (i.e., the amount of resin, unit: % by mass).

TABLE 2

| Example | | 1 | 2 | 3 | 4 | 5 |
|---|---|---|---|---|---|---|
| Liquid set | | LA-1 | LA-2 | LA-3 | LA-4 | LA-5 |
| Ink | | I-1 | I-1 | I-1 | I-1 | I-1 |
| Blending amount | Water | Remaining | Remaining | Remaining | Remaining | Remaining |
| (% by mass) | | amount | amount | amount | amount | amount |
| | Pigment dispersion | 15 | 15 | 15 | 15 | 15 |
| | Resin emulsion R1 | 5(1.5) | 5(1.5) | 5(1.5) | 5(1.5) | 5(1.5) |
| | Resin emulsion R2 | — | — | — | — | — |
| | Resin emulsion R3 | — | — | — | — | — |
| | Surfactant A3 | 1 | 1 | 1 | 1 | 1 |
| | 1,2-propanediol | 10 | 10 | 10 | 10 | 10 |
| | Triethylene glycol monobutyl ether | 10 | 10 | 10 | 10 | 10 |
| | Total | 100 | 100 | 100 | 100 | 100 |
| Cleaning liquid | | CA-1 | CA-2 | CA-3 | CA-4 | CA-5 |
| Blending amount | Water | Remaining | Remaining | Remaining | Remaining | Remaining |
| (% by mass) | | amount | amount | amount | amount | amount |
| | Surfactant S1 | 1 | 1 | 1 | 1 | 1 |
| | Surfactant S2 | — | — | — | — | — |
| | Surfactant A1 | — | — | — | — | — |
| | Surfactant A2 | — | — | — | — | — |
| | Surfactant A3 | — | — | — | — | — |
| | Surfactant X | — | — | — | — | — |
| | 1,2-propanediol | 10 | 10 | 10 | — | — |
| | 1,3-propanediol | — | — | — | 10 | — |
| | Glycerin | — | — | — | — | 10 |
| | Diethylene glycol | — | — | — | — | — |
| | Triethylene glycol monobutyl ether | 10 | 5 | 15 | 10 | 10 |
| | Diethylene glycol monoethyl ether | — | — | — | — | — |
| | Dipropylene glycol monomethyl ether | — | — | — | — | — |
| | Total | 100 | 100 | 100 | 100 | 100 |
| Viscosity (mPa · s) | | 3.5 | 3.0 | 4.0 | 3.0 | 4.0 |
| Contact angle (degree) | | 36 | 36 | 38 | 37 | 38 |
| Evaluation | Cleanability | A | A | A | A | A |
| | Accuracy of ink placement | A | A | A | A | A |
| | Adhesion | A | A | A | A | A |

TABLE 3

| Example | | 6 | 7 | 8 | 9 | 10 |
|---|---|---|---|---|---|---|
| Liquid set | | LA-6 | LA-7 | LA-8 | LA-9 | LA-10 |
| Ink | | I-1 | I-1 | I-2 | I-3 | I-1 |
| Blending amount | Water | Remaining | Remaining | Remaining | Remaining | Remaining |
| (% by mass) | | amount | amount | amount | amount | amount |
| | Pigment dispersion | 15 | 15 | 15 | 15 | 15 |
| | Resin emulsion R1 | 5(1.5) | 5(1.5) | — | — | 5(1.5) |
| | Resin emulsion R2 | — | — | 5(2.3) | — | — |
| | Resin emulsion R3 | — | — | — | 5(1.5) | — |
| | Surfactant A3 | 1 | 1 | 1 | 1 | 1 |
| | 1,2-propanediol | 10 | 10 | 10 | 10 | 10 |
| | Triethylene glycol monobutyl ether | 10 | 10 | 10 | 10 | 10 |
| | Total | 100 | 100 | 100 | 100 | 100 |
| Cleaning liquid | | CA-6 | CA-7 | CA-1 | CA-1 | CA-8 |
| Blending amount | Water | Remaining | Remaining | Remaining | Remaining | Remaining |
| (% by mass) | | amount | amount | amount | amount | amount |
| | Surfactant S1 | 1 | 1 | 1 | 1 | — |
| | Surfactant S2 | — | — | — | — | — |
| | Surfactant A1 | — | — | — | — | 1 |
| | Surfactant A2 | — | — | — | — | — |
| | Surfactant A3 | — | — | — | — | — |
| | Surfactant X | — | — | — | — | — |
| | 1,2-propanediol | 10 | 10 | 10 | 10 | 10 |
| | 1,3-propanediol | — | — | — | — | — |
| | Glycerin | — | — | — | — | — |
| | Diethylene glycol | — | — | — | — | — |
| | Triethylene glycol monobutyl ether | — | — | 10 | 10 | 10 |
| | Diethylene glycol monoethyl ether | 10 | — | — | — | — |
| | Dipropylene glycol monomethyl ether | — | 10 | — | — | — |
| | Total | 100 | 100 | 100 | 100 | 100 |
| Viscosity (mPa · s) | | 3.5 | 3.0 | 3.5 | 3.5 | 3.5 |
| Contact angle (degree) | | 35 | 35 | 37 | 36 | 35 |
| Evaluation | Cleanability | A | A | A | A | A |
| | Accuracy of ink placement | A | A | A | A | A |
| | Adhesion | A | A | A | A | A |

TABLE 4

| Example | | 11 | 12 | 13 | 14 | 15 |
|---|---|---|---|---|---|---|
| Liquid set | | LA-11 | LA-12 | LA-13 | LA-14 | LA-15 |
| Ink | | I-1 | I-1 | I-1 | I-4 | I-5 |
| Blending amount | Water | Remaining | Remaining | Remaining | Remaining | Remaining |
| (% by mass) | | amount | amount | amount | amount | amount |
| | Pigment dispersion | 15 | 15 | 15 | 15 | 15 |
| | Resin emulsion R1 | 5(1.5) | 5(1.5) | 5(1.5) | 3(0.9) | 10(3.0) |
| | Resin emulsion R2 | — | — | — | — | — |
| | Resin emulsion R3 | — | — | — | — | — |
| | Surfactant A3 | 1 | 1 | 1 | 1 | 1 |
| | 1,2-propanediol | 10 | 10 | 10 | 10 | 10 |
| | Triethylene glycol monobutyl ether | 10 | 10 | 10 | 10 | 10 |
| | Total | 100 | 100 | 100 | 100 | 100 |
| Cleaning liquid | | CA-9 | CA-10 | CA-11 | CA-1 | CA-1 |
| Blending amount | Water | Remaining | Remaining | Remaining | Remaining | Remaining |
| (% by mass) | | amount | amount | amount | amount | amount |
| | Surfactant S1 | — | — | — | 1 | 1 |
| | Surfactant S2 | — | — | 1 | — | — |
| | Surfactant A1 | — | — | — | — | — |
| | Surfactant A2 | 1 | — | — | — | — |
| | Surfactant A3 | — | 1 | — | — | — |
| | Surfactant X | — | — | — | — | — |
| | 1,2-propanediol | 10 | 10 | 10 | 10 | 10 |
| | 1,3-propanediol | — | — | — | — | — |
| | Glycerin | — | — | — | — | — |
| | Diethylene glycol | — | — | — | — | — |
| | Triethylene glycol monobutyl ether | 10 | 10 | 10 | 10 | 10 |
| | Diethylene glycol monoethyl ether | — | — | — | — | — |
| | Dipropylene glycol monomethyl ether | — | — | — | — | — |
| | Total | 100 | 100 | 100 | 100 | 100 |
| Viscosity (mPa · s) | | 3.5 | 3.5 | 3.5 | 3.0 | 4.0 |
| Contact angle (degree) | | 35 | 35 | 34 | 36 | 36 |
| Evaluation | Cleanability | A | A | A | A | A |
| | Accuracy of ink placement | A | A | A | A | A |
| | Adhesion | A | A | A | A | A |

TABLE 5

| Comparative Example | | 1 | 2 | 3 |
|---|---|---|---|---|
| Liquid set | | LB-1 | LB-2 | LB-3 |
| Ink | | I-1 | I-1 | I-1 |
| Blending amount | Water | Remaining | Remaining | Remaining |
| (% by mass) | | amount | amount | amount |
| | Pigment dispersion | 15 | 15 | 15 |
| | Resin emulsion R1 | 5 (1.5) | 5 (1.5) | 5 (1.5) |
| | Resin emulsion R2 | — | — | — |
| | Resin emulsion R3 | — | — | — |
| | Surfactant A3 | 1 | 1 | 1 |
| | 1,2-propanediol | 10 | 10 | 10 |
| | Triethylene glycol monobutyl ether | 10 | 10 | 10 |
| | Total | 100 | 100 | 100 |
| Cleaning liquid | | CB-1 | CB-2 | CB-3 |
| Blending amount | Water | Remaining | Remaining | Remaining |
| (% by mass) | | amount | amount | amount |
| | Surfactant S1 | 1 | 1 | — |
| | Surfactant S2 | — | — | — |
| | Surfactant A1 | — | — | — |
| | Surfactant A2 | — | — | — |
| | Surfactant A3 | — | — | — |
| | Surfactant X | — | — | 1 |
| | 1,2-propanediol | 10 | 10 | 10 |
| | 1,3-propanediol | — | — | — |
| | Glycerin | — | — | — |
| | Diethylene glycol | — | — | — |
| | Triethylene glycol monobutyl ether | 3 | 20 | 10 |
| | Diethylene glycol monoethyl ether | — | — | — |
| | Dipropylene glycol monomethyl ether | — | — | — |
| | Total | 100 | 100 | 100 |
| Viscosity (mPa•s) | | 3.0 | 4.0 | 3.5 |
| Contact angle (degree) | | 36 | 45 | 45 |
| Evaluation | Cleanability | C (NG) | C (NG) | C (NG) |
| | Accuracy of ink placement | B (NG) | B (NG) | B (NG) |
| | Adhesion | A | A | A |

As shown in Table 5, the content ratio of glycol ether in the cleaning liquid (CB-1) was less than 5% by mass relative to the mass of the cleaning liquid. The content ratio of glycol ether in the cleaning liquid (CB-2) was greater than 15% by mass relative to the mass of the cleaning liquid. The cleaning liquid (CB-3) contained the surfactant X, but the surfactant X was neither an acetylene surfactant nor a silicone surfactant. Therefore, when evaluated using the cleaning liquid s (CB-1) to (CB-3), the evaluation of the cleanability of the ejection surface of the recording head and the evaluation of the accuracy of ink placement were poor.

As shown in Tables 2 to 4 by contrast, the cleaning liquid s (CA-1) to (CA-11) contained an acetylene surfactant or a silicone surfactant. Furthermore, the content ratio of glycol ether in the cleaning liquid s (CA-1) to (CA-11) was at least 5% by mass and no greater than 15% by mass relative to the mass of the cleaning liquid. Therefore, when evaluated using the cleaning liquid s (CA-1) to (CA-11), the evaluation of the cleanability of the ejection surface of the recording head and the evaluation of the accuracy of ink placement were good.

As also shown in Tables 2 to 5, the inks (I-1) to (I-5) had good adhesion to the prescribed recording medium such as a PET sheet. In general, inks with high adhesion to the prescribed recording medium tend to easily cause cleaning defects when a cleaning liquid is used. However, with the cleaning liquid s (CA-1) to (CA-11), the evaluation of the cleanability of the ejection surface of the recording head and the evaluation of the accuracy of ink placement were good even when the inks (I-1) to (I-5) were used which had high adhesion to the prescribed recording medium.

From the above, it was shown that the cleaning liquid s (CA-1) to (CA-11) encompassed by the present disclosure could clean ink well even when an ink with excellent adhesion to the prescribed recording medium was used. It was also shown that the liquid sets (LA-1) to (LA-15) encompassed by the present disclosure included inks with excellent adhesion to the prescribed recording medium and cleaning liquid s which could clean the inks well.

What is claimed is:

1. A cleaning liquid comprising:
water;
a surfactant; and
glycol ether, wherein
the surfactant is an acetylene surfactant or a silicone surfactant, and
a content ratio of the glycol ether is at least 5% by mass and no greater than 15% by mass relative to a mass of the cleaning liquid.

2. The cleaning liquid according to claim 1, wherein
a contact angle of the cleaning liquid to an austenitic stainless steel plate is no greater than 40 degrees.

3. The cleaning liquid according to claim 1, wherein
a viscosity of the cleaning liquid at 25° C. is no greater than 10.0 mPa·s.

4. The cleaning liquid according to claim 1, wherein
an HLB value of the surfactant is at least 8 and no greater than 14, and
a content ratio of the surfactant is greater than 0.0% by mass and no greater than 1.0% by mass relative to the mass of the cleaning liquid.

5. The cleaning liquid according to claim 1, wherein
the surfactant is the acetylene surfactant, and
the acetylene surfactant has a moiety represented by formula (1), 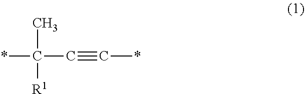
in the formula (1), R¹ represents a group including a hydroxy group and * represents an atomic bonding.

6. The cleaning liquid according to claim 1, wherein
the surfactant is the silicone surfactant, and
the silicone surfactant is polyether-modified silicone.

7. An inkjet recording apparatus liquid set comprising:
a first liquid; and a second liquid, wherein
the first liquid is an ink and the second liquid is a cleaning liquid,
the ink includes pigment particles and water,
the cleaning liquid includes water, a surfactant, and glycol ether,
the surfactant is an acetylene surfactant or a silicone surfactant, and
a content ratio of the glycol ether is at least 5% by mass and no greater than 15% by mass relative to a mass of the cleaning liquid.

8. The inkjet recording apparatus liquid set according to claim 7, wherein
the ink further includes a first resin attached to surfaces of the pigment particles and a second resin in emulsified particle form, and
a content ratio of the second resin is at least 0.9% by mass and no greater than 3.0% by mass relative to a mass of the ink.

9. The inkjet recording apparatus liquid set according to claim 8, wherein
the first resin is a styrene-acrylic resin, and
the second resin is an acrylic resin, polyurethane, or polyolefin.
